(19) United States
(12) Patent Application Publication
(10) Pub. No.: US 2018/0153008 A1
(43) Pub. Date: May 31, 2018

(54) ELECTRONIC CONVERTER, AND RELATED METHOD OF OPERATING AN ELECTRONIC CONVERTER

(71) Applicant: OSRAM GmbH, Munich (DE)

(72) Inventor: Daniele Luccato, Vittorio Veneto (IT)

(21) Appl. No.: 15/821,868

(22) Filed: Nov. 24, 2017

(30) Foreign Application Priority Data
Nov. 25, 2016 (IT) 102016000119833

(51) Int. Cl. H05B 33/08

(52) U.S. Cl. CPC H05B 33/089; H05B 33/0809

(57) ABSTRACT

An electronic converter includes two input terminals for receiving an AC voltage, two output terminals for providing a regulated voltage or current, a rectifier circuit and a boost converter. The boost converter receives at input, via positive and negative input terminals, the DC voltage generated via the rectifier circuit, and provides at output, via positive and negative output terminals, the regulated voltage or current. The boost converter includes an inductor and a diode connected in series between the positive input and output terminals. The boost converter further includes an electronic switch connected between the intermediate point between inductor and diode, and the ground, wherein a capacity is associated with the intermediate point between inductor and diode. The electronic converter further includes a control circuit to drive electronic switch with switching cycles including a first interval, wherein electronic switch is closed, and a second interval wherein electronic switch is opened.

### CROSS-REFERENCE TO RELATED APPLICATION

This application claims priority to Italian Patent Application Serial No. 102016000119833, which was filed Nov. 25, 2016, and is incorporated herein by reference in its entirety.

### TECHNICAL FIELD

Various embodiments generally relate to electronic converters. One or more embodiments may be particularly useful for implementing a converter having Power Factor Correction (PFC).

### BACKGROUND

FIG. 1 shows a typical scenario wherein a load LOAD is supplied via an AC/DC electronic converter 10.

Specifically, in the presently considered example, electronic converter 10 includes two input terminals 102a and 102b and two output terminals 106a and 106b.

In the presently considered example, AC/DC electronic converter 10 includes a DC/DC converter 12, receiving via terminals 104a and 104b a supply signal, i.e. a voltage V_{in,DC} and a current i_{in,DC}, and providing through output terminals 106a and 106b a second supply signal, i.e. a voltage Vₒᵤₜ and a current iₒᵤₜ.

For example, DC/DC converter 12 may be a DC/DC switching supply. For example, non-insulated electronic converters are “buck”, “boost”, “buck-boost”, “Cuk”, “SEPIC” and “ZETA” converters. On the other hand, insulated converters are “flyback” or “forward” converters. Such types of converters are well known to a person skilled in the art.

Therefore, electronic converter 10 further includes a control circuit 14, configured to generate one or more driving signals DRV for driving the DC/DC switching stage so as to regulate voltage Vₒᵤₜ and/or current iₒᵤₜ to a desired value.

As mentioned in the foregoing, electronic converter 10 is supplied with an AC supply signal (e.g. from the mains), i.e. with a voltage Vᵢₙ and a current iᵢₙ. Therefore, electronic converter 10 may include, between input terminals 102a and 102b and input terminals 104a and 104b of the DC/DC switching supply 12, a rectifier circuit 16 configured to convert the AC input current into a DC current; in other words, rectifier circuit 16 receives, via input terminals 102a and 102b, AC voltage Vᵢₙ and provides, via output terminals 104a and 104b, a DC voltage V_{in,DC}.

For example, as shown in FIG. 2, such a rectifier circuit 16 may include a rectifier 164, e.g. a diode bridge rectifier, and optionally one or more filter circuits. For example, FIG. 2 shows an input filter 162 connected between input terminals 102a and 102b, i.e. voltage Vᵢₙ, and the input of rectifier 164, and an output filter 166 connected between the output of rectifier 164 and the input terminals of DC/DC switching supply 12.

Generally speaking, said filters 162 and 166 are merely optional. For example, filter 162 may include an LC filter, i.e. a capacitor C_{Fi} connected in parallel with the input of rectifier 164, and an inductor L_{Fi} connected between one of the input terminals 102a or 102b and the respective input terminal of rectifier 164. On the other hand, filter 164 may include a C filter, i.e. a capacitor C_{Fo} connected in parallel with the output of rectifier 140, i.e. between the terminals 104a and 104b.

As shown in FIG. 3A, load LOAD may be for example a lighting module 20 including e.g. at least one LED L. For example, in this case electronic converter 10 may provide a regulated current, which is useful for supplying a LED lighting module 20.

Generally speaking, as shown in FIG. 3B, one or more further electronic converters 18 may be interposed between output 106a and 106b of electronic converter 10 and load LOAD. For example, the first electronic converter 10 may supply a regulated voltage Vₒᵤₜ, and the second electronic converter 18 may supply a regulated current.

Therefore, the electronic converter 10 shown in FIG. 1 is often supplied by the mains. In this context, the power factor of the system is therefore particularly important. Specifically, the Power Factor (PF) of an AC electrical system is defined as the ratio between the module of the active power vector supplying an electrical load, i.e. converter 10, and the module of the apparent power vector flowing in the circuit, and is equal to the cosine of the offset angle encompassed between the voltage and power vectors.

Therefore, it would be useful if converter 10 could achieve a high power-factor, i.e. approaching 1. For this reason, electronic converter 10 should be an electronic converter with Power Factor Correction (PFC).

Generally speaking, such a PFC electronic converter 10 may also supply load LOAD directly, as shown in FIG. 3A. However, this choice lends itself typically only to small loads, while for high powers it is advantageous to use a second DC/DC electronic converter 18, as shown in FIG. 3B. As a matter of fact, such second electronic converter 18 may have optimized efficiency and no longer needs to take the power factor into account.

In this scenario, also Total Harmonic Distortion (THD) plays an important role. Specifically, this parameter indicates the distortion that the converter introduces into the electrical signals flowing therethrough.

The person skilled in the art will appreciate that various solutions and architectures are known for a PFC electronic converter 10.

For example, FIG. 4 shows the DC/DC switching stage of a PFC converter based on a boost converter.

Specifically, a boost converter includes an inductor L_{B} and a diode D_{B} which are connected (e.g. directly) in series between the positive input terminal 104 and the positive output terminal 106a, while the negative output terminal 106b is connected (e.g. directly) to the negative input terminal 104b, which constitutes a ground GND. Specifically, in the presently considered example, the anode of diode D_{B} is connected to inductor L_{B} and the cathode of diode D_{B} is connected to terminal 106a.

A boost converter moreover includes an electronic switch S_{B} connected (e.g. directly) between the intermediate point between inductor L_{B} and diode D_{B}, and ground GND.

A boost converter often also includes an output capacitor C_{B} connected (e.g. directly) between terminals 106a and 106b. Generally speaking, said output capacitor C_{B} is merely optional. As a matter of fact, said capacitor C_{B} has the function, for example in the case of a resistive load, of keeping output voltage Vₒᵤₜ substantially constant. On the contrary, if load LOAD is a LED module 20 including a chain of LEDS connected (e.g. directly) between terminals 106a and 106b, output voltage Vₒᵤₜ is constrained by the LED voltage itself, and therefore capacitor C_{B} may be omitted, in particular for LEDs L having low dynamic resistance.

Therefore, when switch S_{B} is closed (on state), the current flowing through inductor L_{B} increases. On the other hand, when switch S_{B} is open (off state), the only path available to the current of inductor L_{B} passes through diode D_{B} towards output 106a/106b, thereby optionally charging capacity C_{B}. This induces a transfer of the energy accumulated during the on state towards output 106.

Generally speaking, therefore, the increase of current i_{LB} flowing through inductor L_{B}, i.e. current i_{in,DC}, during the on state depends on the duration of the on state and on the input voltage. Specifically, assuming an ideal behaviour of boost converter 12, input current iᵢₙ is substantially proportional to voltage Vᵢₙ if the closing time of switch S_{B} remains constant. Therefore, the boost converter is particularly suitable to be used within a PFC converter.

Nevertheless, the electronic converter does not have an ideal behaviour, especially when input voltage Vᵢₙ is low, i.e. in the zero-crossing area.

Specifically, in this area, control circuit 14 should therefore control the absorption of current Iᵢₙ in one of these ways:
by directly controlling current i_{LB} flowing through inductor L_{B}, i.e. current i_{in,DC}, e.g. by switching switch S_{B} off when the current flowing through switch S_{B} reaches a required value; or
by indirectly controlling current i_{LB} by regulating the closing time of switch S_{B}.

### SUMMARY

One or more embodiments aim at providing solutions for a PFC electronic converter.

One or more embodiments relate to an electronic converter. The embodiments also concern a corresponding method of operating a converter.

As previously mentioned, the present disclosure refers to an AC/DC electronic converter, specifically a PFC electronic converter. Therefore, the converter includes two input terminals, for receiving an AC voltage, and two output terminals for providing a regulated voltage or current.

In various embodiments, the converter includes a rectifier circuit and a DC/DC electronic converter. Specifically, the rectifier circuit is configured to receive AC voltage at input and to provide DC voltage at output.

In various embodiments, the DC/DC converter is a boost converter. Therefore, the boost converter receives at input, via a positive input terminal and a negative input terminal, the DC voltage generated by the rectifier circuit, and provides at output, via a positive output terminal and a negative output terminal, the regulated voltage or current.

For example, in various embodiments, the boost converter includes an inductor and a diode, connected in series between the positive input terminal and the positive output terminal, and the negative output terminal is connected to the negative input terminal, which represents ground.

In various embodiments, the boost converter moreover includes an electronic switch connected between the intermediate point between the inductor and the diode, and ground. For example, the electronic switch may be a field-effect transistor, preferably with n channel.

As a consequence, generally speaking, a capacity is associated at the intermediate point between the inductor and the diode, e.g. the capacity between the drain and source terminals of a field-effect transistor and/or an additional capacitor.

In various embodiments, the converter moreover includes a control circuit, configured to drive the electronic switch with switching cycles including a first interval, during which the electronic converter is closed, and a second interval during which the electronic switch is open.

In various embodiments, said control circuit is configured to vary, when the electronic switch is closed, the duration of the first interval, so that the regulated voltage or current corresponds to a reference value, i.e. the control circuit opens the electronic switch after a variable time, which enables to obtain the required output voltage or current.

When the electronic switch is opened, therefore, the voltage at the intermediate point between the inductor and the diode starts oscillating, due to the capacity associated to said intermediate point.

Therefore, in various embodiments, the control circuit is configured to detect an increase of the voltage at the intermediate point between the inductor and the diode, and to close the electronic switch again when said voltage increase is detected.

For example, in various embodiments, the control circuit includes a detection circuit configured to determine a signal indicating that the voltage at the intermediate point between the inductor and the diode increases when the electronic switch is open.

For example, in various embodiments, the detection circuit includes detection means configured to generate a measurement signal, preferably a voltage, indicative of the voltage variation at the intermediate point between the inductor and the diode.

For example, in various embodiments, the detection means include a capacitive divider including two capacitors connected in series between the intermediate point between the inductor and the diode, and ground. In this case, the intermediate point between both capacitors may provide the measurement signal. Alternatively, only one capacitor may be used, wherein a first terminal of such a capacitor is connected to the intermediate point between the inductor and the diode, and a second terminal of the capacitor provides the measurement signal.

In various embodiments, the detection circuit may also include means configured to set the measurement signal to a predetermined value when the electronic switch is off.

In various embodiments, the detection circuit may also include means configured to limit the measurement signal between a minimum value and a maximum value. For example, such means may include two clamp diodes.

In various embodiments, the detection circuit may also include a pull-up or pull-down resistor connected to the measurement signal. Such a resistor may be useful if the converter is off, and it ensures that the measurement signal does not remain floating.

Therefore, in various embodiments, the measurement signal indicates an increase of the voltage at the intermediate point between the inductor and the diode. In various embodiments, the detection circuit therefore includes means configured to generate the signal indicating that the voltage at the intermediate point between the inductor and the diode is increasing, by comparing the measurement signal with at least one threshold.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1, 2, 3A, 3B and 4 have already been described in the foregoing,

FIG. 5 shows an electronic converter according to the present disclosure;

FIGS. 6A-6C, 7A-7C and 8A-9C show waveforms illustrating the operation of the electronic converter of FIG. 5;

FIGS. 9A-9C, 10A-10C and 11A-11C show waveforms illustrating the operation of an electronic converter according to the present disclosure;

FIG. 12 shows a detailed embodiment of an electronic converter according to the present disclosure;

FIGS. 13A-13E and 14A-14E show waveforms illustrating the operation of the electronic converter of FIG. 12;

FIG. 15 shows a further detailed embodiment of an electronic converter according to the present disclosure; and

FIGS. 16A-16E show waveforms illustrating the operation of the electronic converter of FIG. 15.

### DETAILED DESCRIPTION

In the following description, various specific details are given to provide a thorough understanding of the embodiments. The embodiments may be practiced without one or several specific details, or with other methods, components, materials, etc. In other instances, well-known structures, materials, or operations are not shown or described in detail in order to avoid obscuring various aspects of the embodiments.

Reference throughout this specification to “one embodiment” or “an embodiment” means that a particular feature, structure, or characteristic described in connection with the embodiment is included in at least one embodiment. Thus, the possible appearances of the phrases “in one embodiment” or “in an embodiment” in various places throughout this specification are not necessarily all referring to the same embodiment. Furthermore, particular features, structures, or characteristics may be combined in any suitable manner in one or more embodiments.

The headings provided herein are for convenience only, and therefore do not interpret the extent of protection or scope of the embodiments.

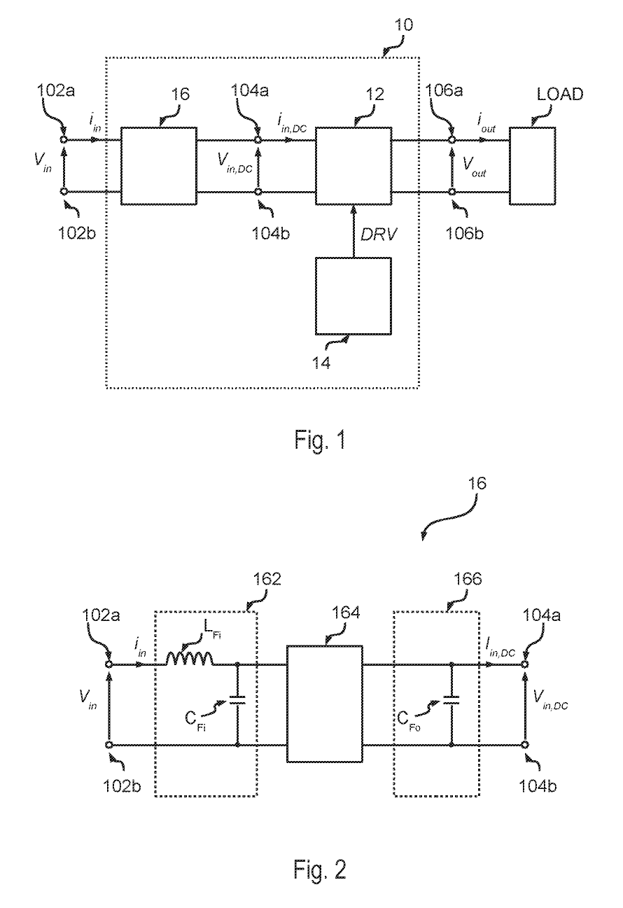

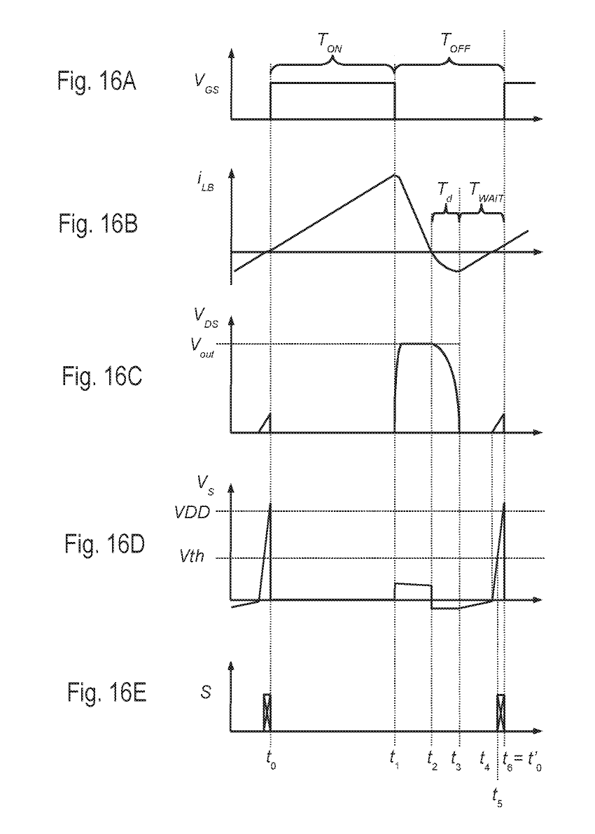

In the following FIGS. 5, 6A-6C, 7A-7C, 8A-8C, 9A-9C, 10A-10C, 11A-11C, 12, 13A-13E, 14A-14E, 15 and 16A-16E the parts, the elements or the components that have already been described with reference to FIGS. 1, 2, 3A, 3B and 4 are denoted by the same references previously adopted in said Figures; the description of such previously described references will not be repeated in the following in order not to overburden the present detailed description.

As mentioned in the foregoing, the present description provides solutions which enable implementing an electronic converter having power factor correction.

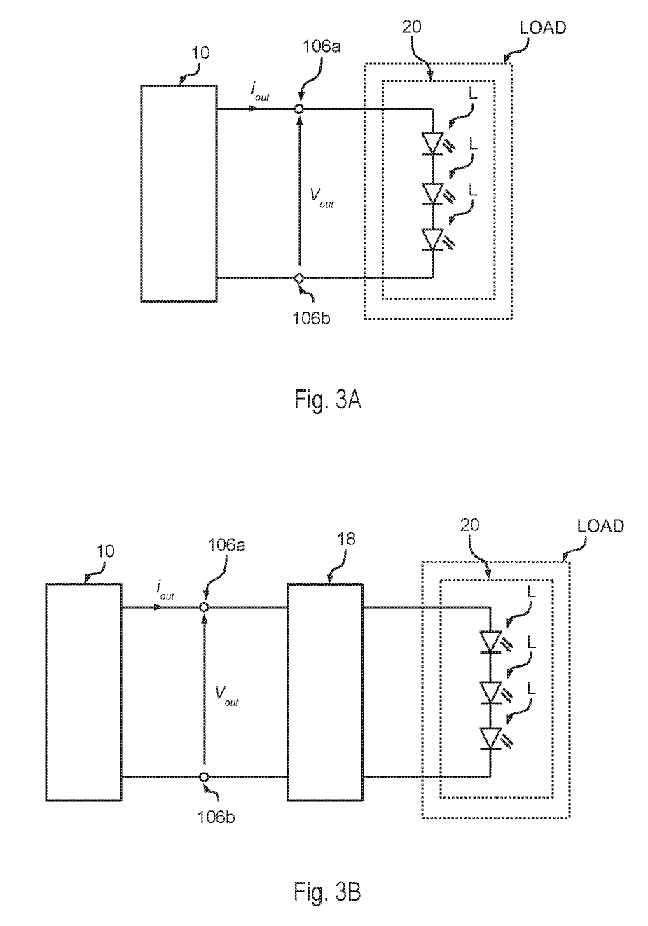

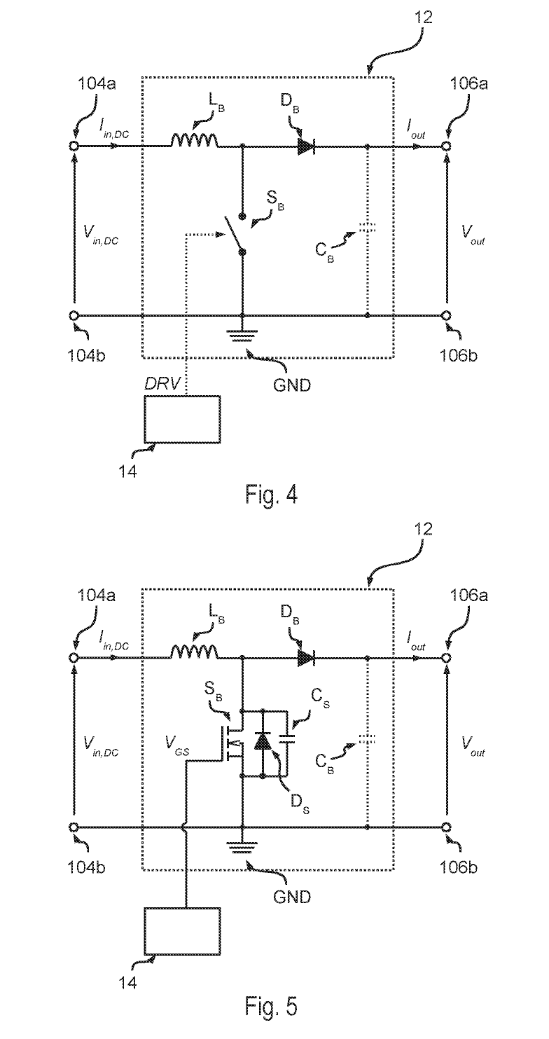

FIG. 5 generally shows the circuit diagram of FIG. 4, i.e. the switching stage 12 of a PFC electronic converter 10 (see also FIG. 1) based on a boost converter which may be used, for example, in the systems shown in FIG. 3A or 3B.

Therefore, in the presently considered embodiment, switching stage 12 includes two input terminals 104a and 104b for receiving a DC voltage V_{in,DC} and two output terminals 106a and 106b for providing a regulated voltage Vₒᵤₜ or a regulated current iₒᵤₜ.

In the presently considered embodiment, switching stage 12 includes an inductor L_{B} and a diode D_{B} which are connected (e.g. directly) in series between the positive input terminal and the positive output terminal 106a, while the negative output terminal 106b is connected (e.g. directly) to the negative input terminal 104b, which represents a ground GND. Specifically, in the presently considered embodiment, the anode of diode D_{B} is connected to inductor L_{B}, and the cathode of diode D_{B} is connected to terminal 106a.

A boost electronic converter moreover includes an electronic switch S_{B} connected (e.g. directly) between the intermediate point between inductor L_{B} and diode D_{B}, and ground GND. Generally speaking, diode D_{B} may therefore be implemented with any other electronic switch D_{B} which is driven in such a way that switch D_{B} is closed when switch S_{B} is open and switch D_{B} is open when switch S_{B} is closed.

Specifically, in the presently considered embodiment, electronic switch S_{B} is a Field-Effect Transistor (FET), such as an n-channel FET. For example, electronic switch S_{B} may be a Metal-Oxide-Semiconductor Field-Effect Transistor (MOSFET).

Therefore, in the presently considered embodiment, electronic switch has, associated thereto, a capacity C_{S}, typically the parasitic capacity of the FET between the drain and source terminals, and a diode D_{S}, typically the body diode, which are connected between the drain and source terminals of the electronic switch S_{B}. Specifically, the anode of diode D_{S} is connected to the source terminal, and the cathode of diode D_{S} is connected to the drain terminal.

Generally speaking, boost converter 12 may operate in a Continuous Conduction Mode (CCM), in a Discontinuous Conduction Mode (DCM) or in the Transition Mode (TM) or Boundary Mode (BM) between CCM and DCM. For example, the Boundary Mode is often used because it enables a simplified implementation of converter 12 and the achievement of low losses.

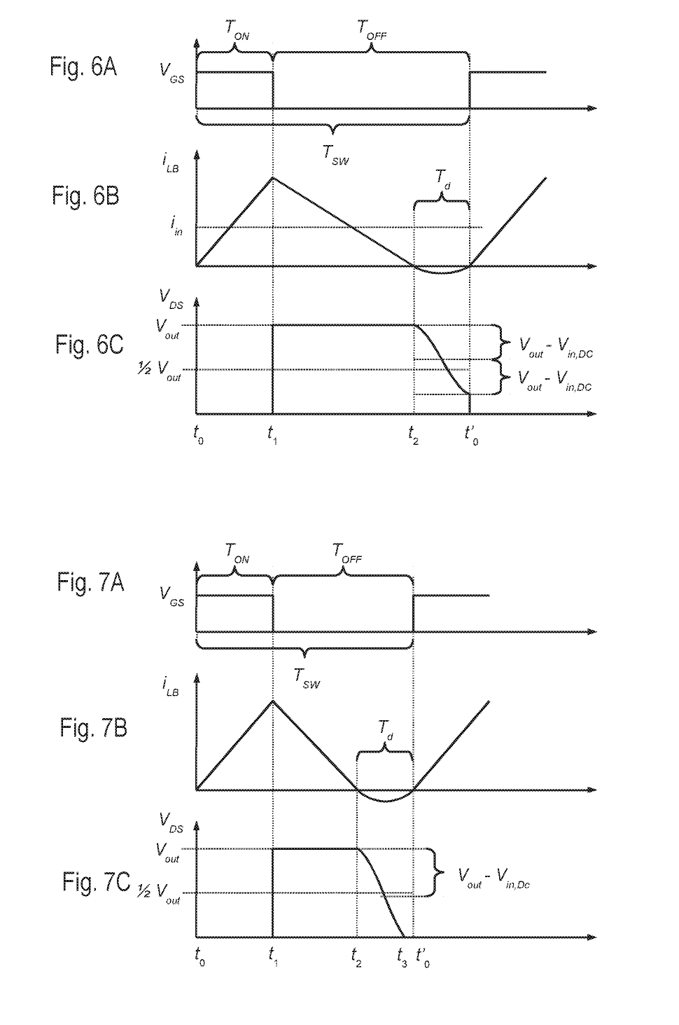

In this respect, FIGS. 6A-6C show a possible driving of electronic switch S_{B}.

Specifically, FIG. 6A shows the driving signal for electronic switch S_{B}, e.g. the voltage V_{GS} between the gate and source terminals of electronic switch S_{B}.

As already explained with reference to FIG. 4, driving signal V_{GS} includes a first interval T_{ON} wherein electronic switch S_{B} is closed, and a second interval T_{OFF} wherein electronic switch S_{B} is open, and these intervals are periodically repeated with a switching period T_{SW}.

Therefore, as shown in FIG. 6B, when electronic switch S_{B} is closed at an instant t₀, interval T_{ON} begins, during which inductor L_{B} is charged with voltage V_{in,DC,} which is applied between input terminals 104a and 104b, and therefore the current i_{LB}=i_{in,DC} flowing through inductor L_{B} increases.

On the other hand, when electronic switch S_{B} is opened at an instant t₁, interval T_{OFF} begins, during which inductor L_{B} is discharged.

Specifically, assuming a DCM or TM/BM operation, inductor L_{B} is completely discharged, and current i_{LB} falls to zero at an instant t₂. Therefore, at instant t₂ also diode D_{B} is opened. As a consequence, during a phase T_{d} between instant t₂ and the following instant t′₀ (when electronic switch S_{B} is closed again), inductor L_{B} and capacity C_{S} oscillate.

Specifically, as shown in FIG. 6B, at the beginning of interval T_{d} current i_{LB} is negative. Therefore, during this phase, the capacity C_{S} associated to electronic switch S_{B} is discharged (see FIG. 6C). Specifically, this behaviour may be used for closing electronic switch S_{B} when voltage V_{DS} between the drain and source terminals of electronic switch S_{B} has reached zero, so-called Zero Voltage Switching (ZVS), or in any case is at a local minimum. Typically, this driving is also denoted valley switching.

Specifically, in the boundary mode driving, the switching at instant to therefore takes place when voltage V_{DS} between the drain and source terminals of electronic switch S_{B} reaches zero or the first local minimum. This sort of driving is typically called quasi-resonant driving.

Specifically, the amplitude of the oscillation at capacity C_{S}, i.e. the oscillation of voltage V_{DS}, during interval T_{d} depends on the input voltage V_{in,DC} between terminals 104a and 104b and on the output voltage Vₒᵤₜ between terminals 106a and 106b.

Specifically, starting from instant t₂ with a voltage V_{DS}=Vₒᵤₜ, voltage V_{DS} oscillates with an amplitude V_{in,DC}−Vₒᵤₜ.

For example, in the embodiment considered in FIGS. 6A-6C, V_{in,DC}>Vₒᵤₜ/2. In this case, the minimum achievable voltage V_{DS} during phase T_{d} is:

V_{DS,min}=2V_{in,DC}−Vₒᵤₜ.

On the other hand, FIGS. 7A-7C shows the corresponding waveform if V_{in,DC}<=Vₒᵤₜ/2. In this case, voltage V_{DS} may therefore reach zero at an instant t₃, i.e. the switching may take place at zero voltage. However, voltage V_{DS} does not fall below zero because of diode D_{S}.

In many applications, the converter may therefore behave either as shown in FIGS. 7A-7C or as shown in FIGS. 6A-6C, because input voltage Vᵢₙ is an AC voltage.

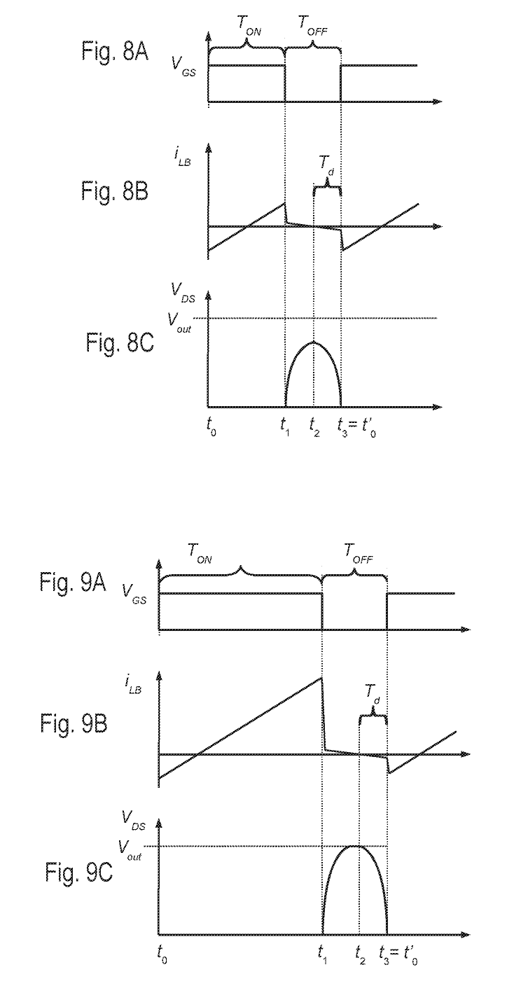

Moreover, as shown in FIG. 8A-8C, when input voltage Vᵢₙ (and therefore also V_{in,DC}) is low, e.g. near zero, the duration of interval T_{ON} may be too short, and therefore the current i_{LB} reached at the end of interval T_{ON}, i.e. at instant t₁, is sufficient to charge capacitor C_{S} and consequently voltage V_{DS} does not reach output voltage Vₒᵤₜ. As a consequence, in this case, no energy is transferred towards output 106a/106b during interval T_{OFF}. Therefore, during period T_{OFF}, inductor L_{B} and capacity C_{S}B oscillate, which is visible in FIG. 8C showing voltage VD). Specifically, also in this case, current i_{LB} becomes negative at an instant t₂ and discharges capacitor C_{S} again until voltage V_{DS} reaches zero.

Therefore, by immediately switching switch S_{B} at instant t₃, negative current i_{LB} must first be recovered, because the first part of interval T_{ON} is necessary to further discharge the energy stored in inductor L_{B}, and only during the second part of interval T_{OFF} current iᵢₙ is positive. However, the duration of the second part may not be sufficient to charge inductor L_{B} and transfer energy to the output.

As a consequence, when input voltage Vᵢₙ (and therefore also V_{in,DC}) is low, particularly at zero-crossing, a short time for interval T_{ON} may not be sufficient to charge inductor L_{B} in such a way that energy may be transferred to the output.

Therefore, the control circuit 14 which drives electronic switch S_{B} should take into consideration the variation of input voltage V_{in,DC}.

In various embodiments, control unit 112 may therefore vary the duration of interval T_{ON} as a function of voltage Vᵢₙ and/or V_{in,DC}. For example, in various embodiments, control unit 112 should increase the duration of interval T_{ON} when the voltage is low, especially when it approaches zero. For example, to this purpose control unit 112 may use a look-up-table (LUT) wherein a respective time for interval T_{ON} is associated to each voltage (or voltage interval) of Vᵢₙ and/or V_{in,DC}.

For example, FIGS. 9A-9C show the waveforms of FIGS. 8A-8C, wherein the duration of interval T_{ON} is longer.

In this case, the current flowing through the inductor reaches a higher value at the end of interval T_{ON}, i.e. at instant t₁. As a consequence, voltage V_{DS} may reach voltage Vₒᵤₜ. Also in this case (see FIG. 9B), current i_{LB} reaches zero at instant t₂ and capacitor C_{S} is discharged until voltage V_{DS} reaches zero at instant t₃. Therefore, also in this case a first part (iᵢₙ<0) of interval T_{ON} is lost. However, by increasing the duration of interval T_{ON}, the duration of the second part of interval (iᵢₙ>0) is increased.

However, this embodiment has the disadvantage of the need of determining the correct LUT or generally speaking the relationship between T_{ON} and Vᵢₙ, for each electronic converter and filter 162/166.

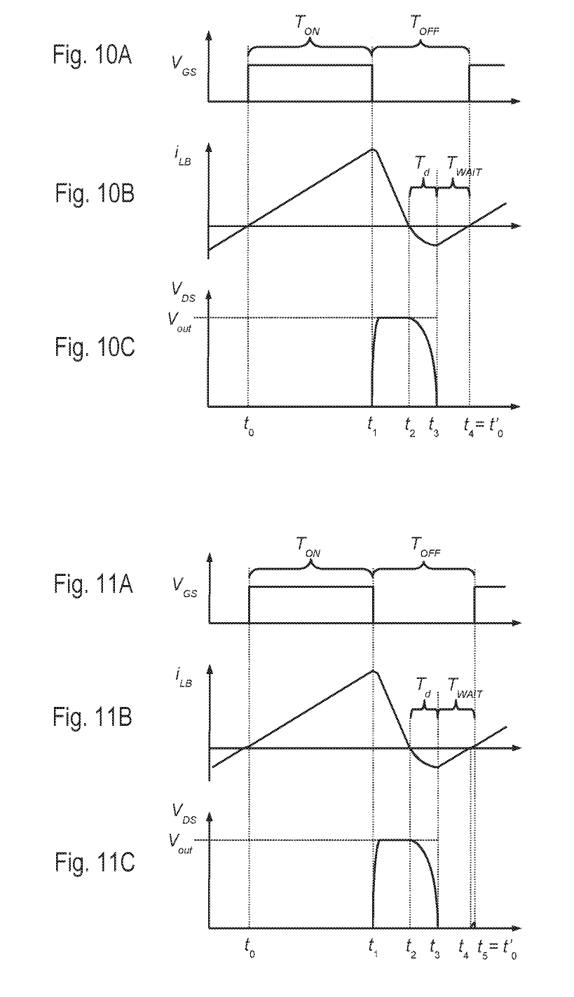

On the other hand, FIGS. 10A-10C show an embodiment wherein an interval T_{WAIT} is added at the end of interval T_{d}. Specifically, such an interval begins at instant t₃ when voltage V_{DS} falls to zero, and ends at an instant t₄ when current i_{LB} flowing through inductor L_{B} reaches zero (see FIG. 10B). Specifically, during interval T_{WAIT} the current will flow through diode D_{S}, because the current is negative (even though switch S_{B} is open). Therefore, in this case, the interval T_{ON} of the following cycle starts when current i_{LB} flowing through inductor L_{B} amounts to zero (t′₀=t₄) and time T_{ON} may remain constant.

For example, control circuit 14 may detect instant t₄ by using a current sensor, such as a shunt resistor connected in series with electronic switch S_{B}.

However, this embodiment has the drawback of needing a current sensor adapted to detect the current flowing through electronic switch S_{B} with high accuracy. For example, for this reason shunt resistor cannot have too low a resistance, which may cause even relevant losses.

FIGS. 11A-11C shows the operation of a control circuit 14 for a boost converter 12 adapted to overcome the previously outlined drawbacks.

Specifically, in the presently considered embodiment, control circuit 14 is configured to implement an interval T_{WAIT} at the end of interval T_{d}; however, S_{B} is not closed at instant to by monitoring the current flowing through switch S_{B}, but as a function of voltage V_{DS}.

Specifically, as shown in FIGS. 11A-11C, at instant t₂ the current i_{LB} flowing through inductor L_{B} becomes negative, and capacity C_{S} is discharged. Therefore, voltage V_{DS} drops and reaches zero at instant t₃. As a consequence, diode D_{S} is closed at instant t₃ and the (negative) current flows through diode D_{S}.

Therefore, also in this case, current i_{LB} increases until, at instant t₄, current i_{LB} flowing through inductor L_{B} reaches zero again, which was detected in the embodiment described with reference to FIGS. 10A-10C.

However, if the switch is not closed at instant t₄, current i_{LB} flowing through inductor L_{B} turns positive again. As a consequence, diode D_{S} is switched off and capacity C_{S} is charged again. Therefore, by charging capacity C_{S} also voltage V_{DS} increases.

In various embodiments, control circuit 14 is therefore configured to detect this increase of voltage Vas in order to start a new switching cycle, i.e. control circuit 14 closes switch S_{B} at an instant t₅ when control circuit 14 detects an increase of the voltage V_{DS}.

Therefore, in the presently considered embodiment, electronic switch S_{B} is not closed at zero voltage. However, the level may nonetheless be kept low, and the losses are lower than in the solution featuring current measurement, which requires e.g. a shunt resistor.

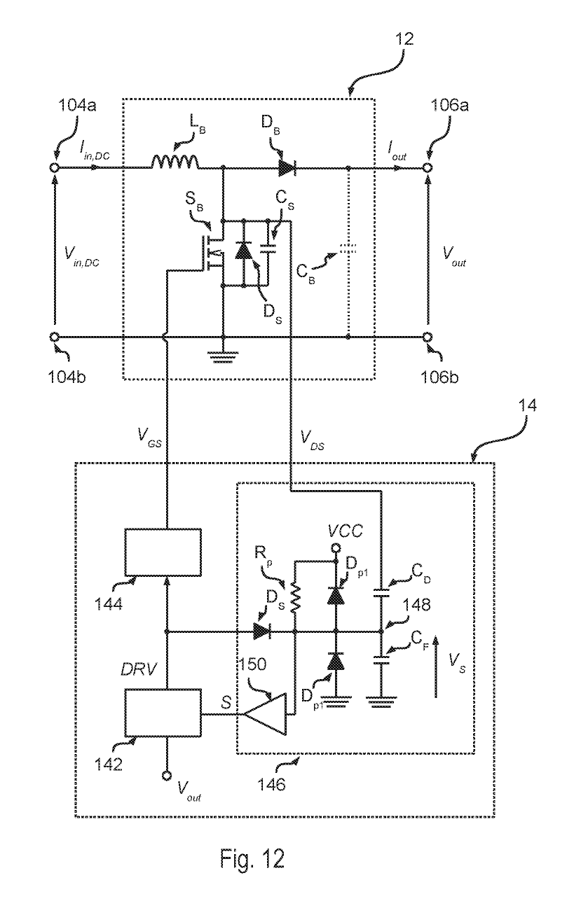

FIG. 12 shows a first embodiment of control circuit 14.

In the presently considered embodiment, control circuit 14 includes a driver 144 for switch S_{B}, such as for example an n-channel MOS driver. Specifically, driver 144 is configured to receive at input a digital control signal DRV and to generate the driving signal for switch S_{B}, i.e. voltage V_{GS} between the gate and source terminals of FET S_{B}. For example, typically, when control signal DRV is high (i.e. has a first logic level), driver 144 generates voltage V_{GS} in such a way as to close transistor S_{B}, and when control signal DRV is low (i.e. has a second logic level), driver 144 generates voltage V_{GS} in such a way as to open transistor S_{B}.

In the presently considered embodiment, control circuit 14 further includes a control unit 142, configured to generate control signal DRV for driver 144. Generally speaking, control unit 142 may be an analog and/or digital circuit, such as e.g. a microprocessor programmed via software code.

Specifically, in various embodiments, control circuit 14 moreover includes a detection circuit 146, configured to monitor voltage V_{DS} between the drain and source terminals of transistor S_{B}, i.e. the voltage at the intermediate point between inductor L_{B} and diode D_{B}, and to generate a control signal S indicative of whether voltage V_{DS} is increasing.

For example, in the presently considered embodiment, detection circuit 146 includes a capacitive divider including two capacitors C_{D} and C_{F} connected (e.g. directly) between the drain terminal of transistor S_{B} and ground GND, i.e. the source terminal of transistor S_{B}. Specifically, in the presently considered embodiment, a first terminal of capacitor C_{D} is connected (e.g. directly) to the drain terminal of transistor S_{B}, the second terminal of capacitor C_{D} is connected (e.g. directly) to a first terminal of capacitor C_{F}, and the second terminal of capacitor C_{D} is connected (e.g. directly) to ground GND. For example, in various embodiments, the capacity of capacitor C_{D} is higher than the capacity of capacitor C_{F}. For this reason, generally speaking, the second capacitor C_{F} is purely optional, and may be useful for filtering signal S. For example, the capacity of capacitor C_{D} may range between 47 pF (picofarad) and 1 nF (nanofarad), and the capacity of C_{F} may range between 10 pF and 220 pF. Generally speaking, also in this case the second capacitor is purely optional, and may be useful for filtering signal S.

Therefore, the intermediate point 148 of the capacitive divider provides a voltage V_{S} which is indicative of voltage V_{DS}. Generally speaking, it would be possible to use a voltage divider with two resistors. The capacitive divider or the voltage divider is typically required, because voltage V_{DS} may exceed the maximum allowable voltage for control unit 142, e.g. in case a microprocessor is used. For example, voltage Vₒᵤₜ may also be included in the range of 350-500 VDC. Generally speaking, it is also possible to use other circuits, configured to generate a signal V_{S} indicative of voltage V_{DS}. For example, the circuit may also include an amplifier.

Therefore, control unit 142 may monitor the signal at node 148, i.e. voltage V_{S}, in order to detect an increase in voltage V_{DS}.

For example, in various embodiments, control circuit 14, e.g. control unit 142 or detection circuit 146, may include a comparator 150, such as a Schmitt trigger, configured to generate a signal S by comparing voltage V_{S} with a reference threshold, such as e.g. VDD/2. For example, such a comparator/Schmitt trigger is typically provided for the input pins of a microprocessor, and therefore it may be integrated into control unit 142.

For example, in various embodiments, the respective connection pin of control unit 142 may be configured to generate an interrupt which therefore enables an automatic detection of the increase of voltage V_{DS}. However, control unit 142 may also periodically monitor signal S in order to detect the increase of voltage V_{DS}.

In the presently considered embodiment, the detection circuit 146 also includes other components which lead to an improvement of the operation of the capacitive divider.

Specifically, in various embodiments, detection circuit 116 may include two clamp diodes Dₚ₁ and Dₚ₂, which limit voltage V_{S}. For example, in the presently considered embodiment, clamp diodes Dₚ₁ and Dₚ₂ are connected in series between a constant voltage VCC (typically the supply voltage VDD used by control unit 142), such as e.g. 3.3 V, and ground GND. Specifically, in the presently considered embodiment, the anode of diode Dₚ₁ is connected (e.g. directly) to ground, the cathode of diode Dₚ₁ is connected (e.g. directly) to the anode of diode Dₚ₂, and the cathode of diode Dₚ₂ is connected (e.g. directly) to voltage VCC. In this case, node 148 is connected (e.g. directly) at the intermediate point between both diodes Dₚ₁ and Dₚ₂. For example, if control unit 142 is an integrated circuit, such as e.g. a microprocessor, diodes Dₚ₁ and Dₚ₂ are often already present within the integrated circuit for the protection of the connection pin.

In various embodiments, the detection circuit may also include a pull-up or pull-down resistor. For example, in the presently considered embodiment, a resistor R_{P} is used which is connected (e.g. directly) between voltage VCC and node 148. Such a resistor R_{P} is useful for ensuring a static condition, so that voltage V_{S} does not remain floating. For example, this resistor may have a resistance in the range from a few kohm to a few megaohm.

In various embodiments, the detection circuit also includes means for resetting capacitor C_{F}.

For example, in the presently considered embodiment, for this purpose a diode D_{S} is used which is connected (e.g. directly) between control signal DRV and node 148. Specifically, the anode of diode D_{S} is connected (e.g. directly) to signal DRV, or the associated output of control unit 142 and the associated input of driver 144, and the cathode is connected (e.g. directly) to node 148.

Therefore, assuming that also control signal DRV varies between zero volt and VDD, capacitor C_{F} is charged substantially to voltage VDD (less the forward voltage VF of diode D_{S}, such as e.g. 0.7 V) when control signal DRV is high. As will be better detailed in the following, this diode is adapted to inhibit a trigger in signal S when voltage V_{DS} rises after instant t₁. Therefore, this diode is merely optional, because control unit 142 may also discard this trigger.

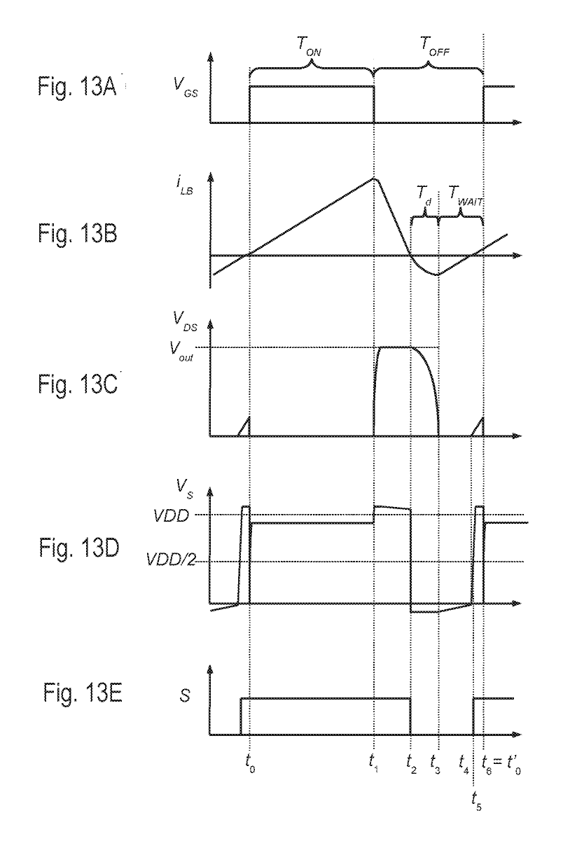

The operation of control circuit 14, specifically of detection circuit 146 shown in FIG. 12, will now be described with reference to FIGS. 13A-13E, which shows a typical switching cycle.

Specifically, the Figures show:

FIG. 13A voltage V_{GS}, which substantially corresponds to control signal DRV;

FIG. 13B current i_{LB} flowing through inductor L_{B},

FIG. 13C voltage V_{DS},

FIG. 13D voltage V_{S}, and

FIG. 13E signal S.

Also in this case, switch S_{B} is closed at instant t₀. For example, in the presently considered embodiment, control unit 142 may set control signal DRV to high. Therefore, during this step T_{ON}, current i_{LB} flowing through inductor L_{B} increases.

During this phase, diode D_{S} sets node 148 to high, e.g. VDD−VF. Therefore, signal S is high.

At an instant t₁, switch S_{B} is opened. For example, in the presently considered embodiment, processing unit 142 may set control signal DRV to low.

In various embodiments, control unit 142 may be configured to vary the duration of interval T_{ON} between instants t₀ and t₁ as a function of output voltage Vₒᵤₜ or of output current iₒᵤₜ. For example, by providing a constant voltage Vₒᵤₜ, such a voltage tends to decrease when input voltage Vᵢₙ falls (assuming that the time for interval T_{ON} remains constant). Therefore, control unit 142 will increase the duration of interval T_{ON} in such a way as to increase again voltage Vₒᵤₜ to the desired value.

Therefore, in this phase, current i_{LB} charges capacitor C_{S} until voltage V_{DS} reaches voltage Vₒᵤₜ, and subsequently current i_{LB} is transferred towards output 106. Therefore, during this step (t₁-t₂), current i_{LB} decreases until current i_{LB} reaches zero at instant t₂.

The variation of voltage V_{DS} is also transferred to capacitor C_{F}, i.e. voltage V_{S} increases. However, thanks to the clamp diodes, voltage V_{S} is limited to VDD+V_{F}.

From instant t₂, current i_{LB} is negative, and capacity C_{S} is discharged. Therefore, also voltage V_{S} decreases. Specifically, also in this case voltage V_{S} is limited, via the clamp diodes, to a voltage substantially corresponding to −V_{F}.

Therefore, a short time after instant t₂, signal S falls to zero, because voltage V_{S} falls below the threshold of comparator 150, e.g. below VDD/2.

Consequently, voltage V_{S} and signal S stay low throughout period (t₂-t₄) during which current i_{LB} is negative, i.e. also at the instant when voltage V_{DS} reaches zero.

At instant t₄, current i_{LB} becomes positive and charges capacity C_{S}. This variation of voltage V_{DS} is also transferred, via capacitor C_{D}, to capacitor C_{F}, and voltage V_{S} rapidly increases.

Therefore, after a short interval, comparator 150 detects that voltage V_{S} has exceeded the reference threshold, e.g. VDD/2, and signal S is set to high at an instant t₅.

When control unit 142 has detected the variation of signal S at an instant t₆, control unit 142 may start a new cycle, by setting control signal DRV e.g. to high.

Therefore, in the presently considered embodiment, the control circuit is configured to close switch S_{B} when signal S indicates that voltage V_{DS} is increasing, while the duration of the on time during which switch S_{B} is closed is determined as a function of the output voltage or current.

If voltage V_{DS} does not fall to zero, as shown in FIGS. 6A-6C, the circuit shown in FIG. 12 in any case detects when voltage V_{DS} increases again.

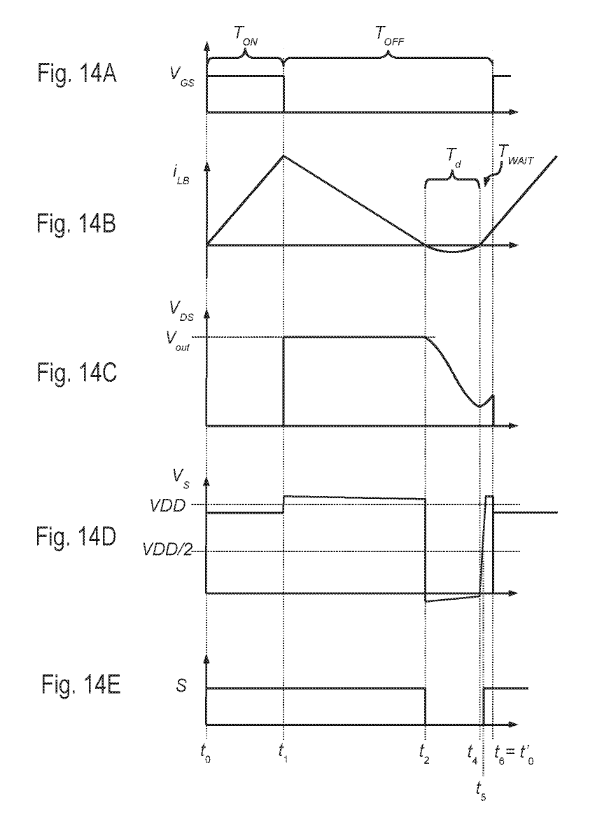

Specifically, as shown in FIGS. 14A-14E, also in this case detection circuit 146, specifically diode D_{S}, keeps signal S high during interval T_{ON} (t₀-t₁). Therefore, comparator 150 sets signal S to high.

At instant t₁, switch S_{B} is opened. Therefore, at instant t₁ current i_{LB} charges capacity C_{S} and voltage V_{DS} increases. Detection circuit 146, specifically capacitor C_{D}, transfers this increase of voltage V_{DS} to voltage V_{S}, which however is limited by clamp diodes D_{P1}/D_{P2}. However, because the level was already high, signal S does not change its level.

Once current I_{LB} reaches zero at instant t₂, capacity C_{S} is discharged and voltage V_{DS} decreases. Detection circuit 146, specifically capacitor C_{D}, transfers this decrease of voltage V_{DS} to voltage V_{S}, which however is limited by clamps D_{P1}/D_{P2}. Comparator 150 detects this variation, and signal S is set to low.

Specifically, because voltage Vᵢₙ is high, voltage V_{DS} does not reach zero, but only a local minimum. Therefore, current i_{LB} turns to zero again at instant t₄, and capacity C_{S} is charged and voltage V_{DS} increases. Detection circuit 146, specifically capacitor C_{D}, transfers again this increase of voltage V_{DS} to voltage V_{S}, which again is limited via clamp diodes Dₚ₁/Dₚ₂. Comparator 150 detects this variation and signal S is set to high.

When control unit 142 has detected the variation of signal S at an instant t₆, control unit 142 may start a new cycle, by setting control signal DRV e.g. to high.

Therefore, detection circuit 146 represents a valley detector, configured to generate a signal S which indicates when voltage V_{DS} increases. On the other hand, control unit 142 (together with driver 144) is configured for:
when switch S_{B} is open, i.e. during interval T_{OFF}, and signal S indicates that voltage V_{DS} increases, closing switch S_{B}, and
opening switch S_{B} after an interval T_{ON}, wherein the duration of interval T_{ON} is determined as a function of output voltage Vₒᵤₜ or output current iₒᵤₜ.

In various embodiments, detection circuit 146 may be used to transform a conventional boost transformer into a PFC converter.

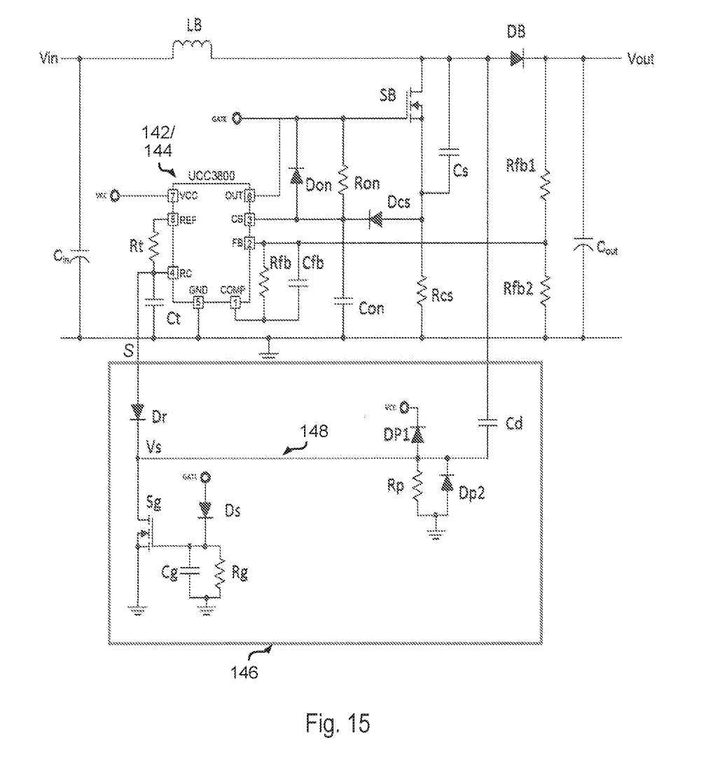

For example, FIG. 15 shows a boost converter employing, as a control unit, a UCC3800 control integrated circuit.

Also in this case the boost converter includes an inductor L_{B}, a diode D_{B} and a switch S_{B}, e.g. a FET S_{B}, which has a diode (not shown) and a capacity C_{S} associated thereto.

Typically, the converter includes an input capacitor Cᵢₙ (which may be a part of rectifier circuit 16) and an output capacitor Cₒᵤₜ.

Substantially, UCC3800 control unit 142 is a PWM controller, having a constant oscillation frequency, wherein the on time is regulated as a function of the output voltage (detected by a pin FB) and of the current flowing through switch S_{B} (detected by a pin C_{S}).

For example, in the presently considered embodiment, a feedback signal FB is generated indicative of output voltage Vₒᵤₜ. For example, in the presently considered embodiment, feedback signal FB is obtained by using a voltage divider R_{fb1}/R_{fb2} and optionally a compensation network R_{fb} and C_{fb}. Specifically, the intermediate point of voltage divider R_{fb1}/R_{fb} provides feedback signal FB. On the other hand, resistor R_{fb} and capacitor C_{fb} are connected in parallel between signal FB and output COMP of the UCC3800 circuit. Specifically, the signal applied at output COMP is generated within the UCC3800 circuit by a comparator which compares signal FB with a reference signal.

As mentioned in the foregoing, the UCC3800 circuit also uses a signal C_{S} indicative of the current flowing through switch S_{B}. For example, in the presently considered embodiment, the current flowing through switch S_{B} is detected by a shunt resistor R_{cs} connected in series with switch S_{B}.

As previously mentioned, the on time T_{ON} is regulated within the UCC3800 circuit as a function of signal CS and of signal FB (i.e. the resulting signal COMP). Specifically, time T_{ON} finishes when the voltage at pin CS crosses the reference voltage at pin COMP.

In various embodiments, in order to make the regulation substantially independent from the current flowing through switch S_{B}, a network Rₒₙ/Cₒₙ and a diode D_{cs} are added. Specifically, resistor Rₒₙ is connected between the gate terminal of transistor S_{B} and signal CS, and capacitor Cₒₙ is connected between signal CS and ground GND. On the other hand, diode D_{cs} is connected between resistor R_{cs} and signal CS. As a consequence, resistor Rₒₙ charges capacitor Cₒₙ when voltage V_{GS} is high. Once capacitor Cₒₙ is charged, diode D_{cs} is opened and the voltage at resistor R_{cs} no longer influences signal CS (except in instances of malfunction). Therefore, time T_{ON} ends when the voltage at capacitor Cₒₙ crosses reference COMP. In various embodiments, a diode Dₒₙ may be present which is connected in parallel with resistor Rₒₙ, which enables discharging capacitor Cₒₙ when voltage V_{GS} is low.

As previously stated, UCC3800 circuit is a PWM controller, having a constant oscillation frequency. For this purpose, circuit 142 has a resistor Rₜ and a capacitor Cₜ connected in series associated thereto, which represent a filter RC defining the oscillation frequency of the inner oscillator.

Therefore, in order to convert the boost converter into a PFC controller as described in the foregoing, control unit 142 should be activated not at a fixed frequency, but when detector 146 detects an increase of voltage V_{DS}, or in general the voltage at the intermediate point between inductor L_{B} and diode D_{B}.

Therefore, FIG. 15 shows an embodiment wherein a capacitor Cₜ is used having a very small capacity. In this case, detection circuit 146 is used for generating a signal S which deactivates charging capacitor Cₜ, until an increase of voltage V_{DS} is detected.

For example, in the presently considered embodiment, capacitor Cₜ is substantially short-circuited, and capacitor Cₜ is not charged when voltage V_{DS} is low. On the contrary, when an increase of voltage V_{DS} is detected, capacitor Cₜ may be charged in a short time, and control unit 142 starts a new switching cycle.

Specifically, in the presently considered embodiment, signal S is applied at the intermediate point between resistor Rₜ and capacitor Cₜ. Therefore, signal S should stay low until two conditions are satisfied:

a) transistor S_{B} is open, and

b) an increase of voltage between the drain terminal of transistor S_{B} and ground GND is detected.

If both conditions are met, signal S should be set to a high impedance state, so that capacitor Cₜ may be charged.

For example, in the presently considered embodiment, the detection of condition a) is implemented once again via a reset circuit, which in this case has inverted levels. Therefore, in the presently considered embodiment, beside a diode D_{S} as previously used, an electronic switch S_{g} is added, such as e.g. an n-channel FET. Specifically, in the presently considered embodiment, the anode of diode D_{S} is connected (e.g. directly) to voltage V_{GS} and not to signal DRV, which at any rate represents an equivalent signal. On the other hand, the cathode of diode D_{S} is connected (e.g. directly) to the gate terminal of transistor S_{g}. Finally, the source terminal of transistor S_{g} is connected (e.g. directly) to ground GND. Therefore, the drain terminal of transistor S_{g} is substantially connected to ground GND when signal V_{GS} and therefore signal DRV is high, i.e. when switch S_{B} is closed. As a consequence, switch S_{g} substantially implements an inverter.

In various embodiments, the gate terminal of transistor S_{g} may also have a filter associated thereto, e.g. a capacitor C_{g} and a resistor R_{g} which are connected in parallel between the gate terminal of transistor S_{g} and ground GND. The operation of said filter will be described in the following.

On the contrary, condition b) is detected, as previously described, via a capacitive divider including a capacitor C_{d} and the capacity between the drain and source terminals of transistor S_{g}. Therefore, in the presently considered embodiment, capacitor C_{d} is connected (e.g. directly) between the drain terminal of transistor S_{B}, i.e. the intermediate point between L_{B} and diode D_{B}, and the drain terminal of transistor S_{g}, which represents node 148 in the embodiment described with reference to FIG. 12. Generally speaking, also in this case, the second capacitor is purely optional, and may be useful for filtering signal S.

Therefore, the intermediate point 148 between capacitor C_{d} and the drain terminal of transistor S_{g} supplies voltage V_{S} again, which indicates if voltage V_{DS} is increasing, the only difference being that in FIG. 12 voltage V_{S} is set to a high value when switch S_{B} is closed, while in FIG. 15 voltage V_{S} is set to a low value when switch S_{B} is closed.

Also in this case there may be provided a resistor Rₚ to set the capacitive divider to a static condition. For example, with reference to the previously described operation, a pull-down resistor is advantageous.

As a consequence, when switch S_{B} is closed at instant t₀, voltage V_{S} is set to zero via diode Dₛ and switch S_{g}.

On the other hand, when switch S_{B} is opened at instant t₁, the (positive) current i_{LB} charges capacity C_{S} and voltage V_{DS} increases. Therefore, capacitor Ca transfers this variation to node 148. However, as the gate terminal of switch S_{g} has filter C_{g}/R_{G} associated thereto, switch S_{g} still remains closed, and the current provided by capacitor Ca is discharged to ground GND, i.e. such rise of voltage V_{DS} is suppressed.

At instant t₂, current i_{LB} becomes negative and voltage V_{DS} decreases. Capacitor C_{d} transfers this variation to node 148, which however is already low, and the (negative) voltage at node 148 is limited by clamp diodes Dₚ₁ and Dₚ₂.

Finally, when current i_{LB} turns positive again at instant t₄, voltage V_{DS} increases. Capacitor C_{d} transfers also this variation to node 148, i.e. voltage V_{S} increases.

In the presently considered embodiment, a diode Dr is used to transfer this variation of voltage V_{S} to capacitor Cₜ. Specifically, the anode of diode Dr is connected (e.g. directly) at the intermediate point between resistor Rₜ and capacitor Cₜ. On the other hand, the cathode of diode Dr is connected (e.g. directly) to node 148. Therefore, when voltage V_{S} is low, i.e. substantially zero, the voltage at capacitor Cₜ is drawn to ground. On the other hand, when voltage V_{S} rises and, at an instant t₆, exceeds voltage Vₜₕ at capacitor Cₜ, diode Dᵣ opens, i.e. signal S does not inhibit the charging of capacitor Cₜ any longer. As a consequence, by charging capacitor Cₜ, control unit 142 detects an oscillation cycle and starts a new switching cycle at instant t₆.

Therefore, in the presently considered embodiment, the function of comparator 150 of FIG. 12 is now performed by diode Dᵣ. As a matter of fact, instead of diode Dᵣ other means may be used, e.g. a comparator and an electronic switch, which may be configured to selectively short-circuit capacitor Cₜ when voltage V_{S} is lower than a given threshold, i.e. in general as a function of the voltage at the intermediate point between inductor L_{B} and diode D_{B}.

Generally speaking, the embodiment shown in FIG. 15, featuring means to activate or deactivate the oscillator of control unit 142 as a function of voltage V_{DS}, i.e. the voltage at the intermediate point between inductor L_{B} and diode D_{B}, may also be applied to other controllers with current and/or voltage control. As a matter of fact, the circuit shown in FIG. 15 substantially transforms a circuit having a fixed switching frequency and PWM modulation into a quasi-resonant circuit, wherein the on time T_{ON} is varied (i.e. increased or decreased) as a function of the output voltage or current.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An electronic converter comprising:
two input terminals for receiving an AC voltage and two output terminals for providing a regulated voltage or current;
a rectifier circuit configured for receiving at input said AC voltage and providing at output a DC voltage;
a boost converter configured for receiving at input via a positive input terminal and a negative input terminal said DC voltage and providing at output via a positive output terminal and a negative output terminal said regulated voltage or current, said boost converter comprising:
an inductor and a diode connected in series between said positive input terminal and said positive output terminal, wherein said negative output terminal is connected to said negative input terminal, which represents a ground,
an electronic switch connected between the intermediate point between said inductor and said diode, and said ground, wherein a capacity is associated with the intermediate point between said inductor and said diode;
a control circuit configured to drive said electronic switch with switching cycles comprising a first interval wherein said electronic switch is closed and a second interval wherein said electronic switch is opened;
wherein said control circuit is configured for:
when said electronic switch is opened:
detecting an increase of the voltage at the intermediate point between said inductor and said diode;
closing said electronic switch when an increase of the voltage at the intermediate point between said inductor and said diode is detected;
when said electronic switch is closed:
varying the duration of said first interval such that said regulated voltage or current corresponds to a reference value.

2. The electronic converter according to claim 1, wherein said electronic switch is a field effect transistor.

3. The electronic converter according to claim 1, wherein said control circuit comprises a detection circuit configured to determine a signal indicative of the fact that the voltage at the intermediate point between said inductor and said diode increases when said electronic switch is opened.

4. The electronic converter according to claim 3, wherein said detection circuit comprises detection means configured to generate a measurement signal, indicative of the variation of the voltage at the intermediate point between said inductor and said diode.

5. The electronic converter according to claim 4, wherein said detection means comprise:
a capacitor, wherein a first terminal of said capacitor is connected to said intermediate point between said inductor and said diode, and a second terminal of said capacitor provides said measurement signal; or
a capacitive voltage divider comprising two capacitors connected in series between said intermediate point between said inductor and said diode, and said ground, wherein the intermediate point between said two capacitors provides said measurement signal.

6. The electronic converter according claim 4, wherein said detection circuit comprises means configured to set said measurement signal to a predetermined value when said electronic switch is closed.

7. The electronic converter according to claim 4, wherein said detection circuit comprises means configured to limit said measurement signal between a minimum value and a maximum value.

8. The electronic converter according to claim 7, wherein said means configured to limit said measurement signal between a minimum value and a maximum value comprise two clamping diodes.

9. The electronic converter according to claim 4, wherein said detection circuit comprises a pull-up or pull-down resistor connected to said measurement signal.

10. The Electronic converter according to claim 3, wherein said detection circuit comprises means configured to generate said signal indicative of the fact that the voltage at the intermediate point between said inductor and said diode increases by comparing said measurement signal with at least one threshold.

11. A method of operating an electronic converter, the electronic converter comprising:
two input terminals for receiving an AC voltage and two output terminals for providing a regulated voltage or current;
a rectifier circuit configured for receiving at input said AC voltage and providing at output a DC voltage;
a boost converter configured for receiving at input via a positive input terminal and a negative input terminal said DC voltage and providing at output via a positive output terminal and a negative output terminal said regulated voltage or current, said boost converter comprising:
an inductor and a diode connected in series between said positive input terminal and said positive output terminal, wherein said negative output terminal is connected to said negative input terminal, which represents a ground,
an electronic switch connected between the intermediate point between said inductor and said diode, and said ground, wherein a capacity is associated with the intermediate point between said inductor and said diode;
a control circuit configured to drive said electronic switch with switching cycles comprising a first interval wherein said electronic switch is closed and a second interval wherein said electronic switch is opened;
the method comprising:
when said electronic switch is opened:
detecting an increase of the voltage at the intermediate point between said inductor and said diode;
closing said electronic switch when an increase of the voltage at the intermediate point between said inductor and said diode is detected;
when said electronic switch is closed:
varying the duration of said first interval such that said regulated voltage or current corresponds to a reference value.
